(19) United States
(12) Patent Application Publication
(10) Pub. No.: US 2005/0061125 A1
(43) Pub. Date: Mar. 24, 2005

(54) Device to cut films

(75) Inventor: Hans Rosch, Obergunzburg (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(73) Assignee: nicepAC Gmbh, Obergunzburg (DE)

(21) Appl. No.: 10/926,777

(22) Filed: Aug. 26, 2004

(30) Foreign Application Priority Data
Aug. 27, 2003 (DE) 203 13 228.9

(51) Int. Cl. B26D 5/32; B26D 1/40

(52) U.S. Cl. 83/349; 83/344; 83/305; 83/669

(57) ABSTRACT

An apparatus to cut films, in particular, soft films, with a first carrier and a second carrier, which is, in contrast to the first carrier, movable, of which one carries a blade holder with a movable blade and the other, a counterpiece corresponding to the blade. In order to attain a compact structure, the blade holder has a pressure piston, on which the blade is held in such a way that it can be replaced. The piston is conducted so that it can be displaced within a housing and can be moved by a pressure fluid in the direction of the counterpiece.

### BACKGROUND OF THE INVENTION

1. Field of the Invention

The invention relates an apparatus or device to cut films, in particular, soft films.

2. Prior Art

Such apparatuses or devices are used, for example, in the packaging industry to cut or punch soft films. They usually have a first carrier and a second carrier, which, in contrast to the first carrier, is movable, of which one carries a blade holder with a movable blade and the other, a counterpiece corresponding to the blade in the form of a pressure ridge or the like. By moving the second carrier, which is movable by means of a drive, in the direction of the first carrier, the films to be cut are first clamped. Subsequently, the cutting blade is moved relative to the counterpiece, wherein the film is cut. With known devices of this type, there is the problem that the blade holder with the corresponding drives takes up a relatively large structural space. In this way, difficulties in accommodating the blade holder in the space available within the device arise.

### SUMMARY OF THE INVENTION

This problem the invention solves by creating an apparatus or device (hereinafter referred to as “device”) of the type mentioned above that has a compactly constructed and universally useable blade holder.

With the device in accordance with the invention, the blade holder has a pressure piston, on which the cutting blade is held so it can be replaced and which is conducted so that it can be shifted within a housing and can be moved by a pressure fluid in the direction of the counterpiece.

In a particularly advantageous and space-saving embodiment of the invention, the pressure piston is constructed in the form of a pressure plate. The housing forming the installation for the pressure piston is appropriately composed of a frame-like basic part, an upper cover plate, and two lower side plates. A gap for the blade is formed between the two lower side plates.

By acting on the pressure piston with pressure fluid, preferably compressed air, the pressure piston can be moved in such a way that the blade is moved through the gap in the direction of the counterpiece. In this way, a film or another suitable material can be cut. With the aid of pressure springs, the pressure piston is pressed into its starting position, in which the blade is located within the housing.

### BRIEF DESCRIPTION OF THE DRAWINGS

Other particulars and advantages of the invention can be deduced from the following description of a preferred embodiment with the aid of the drawing. Shown are:

FIG. 1, a part of a device in accordance with the invention for the cutting of films in a partially cut front view;

FIG. 2, a part of a blade holder of the device shown in FIG. 1 in a front view;

FIG. 3, the part of the blade holder shown in FIG. 2 in a topview;

FIG. 4, a side view of the blade holder shown in FIG. 2 in a first section; and

FIG. 5 a side view of the blade holder shown in FIG. 2 in a second section.

### DETAILED DESCRIPTION OF PREFERRED EMBODIMENTS

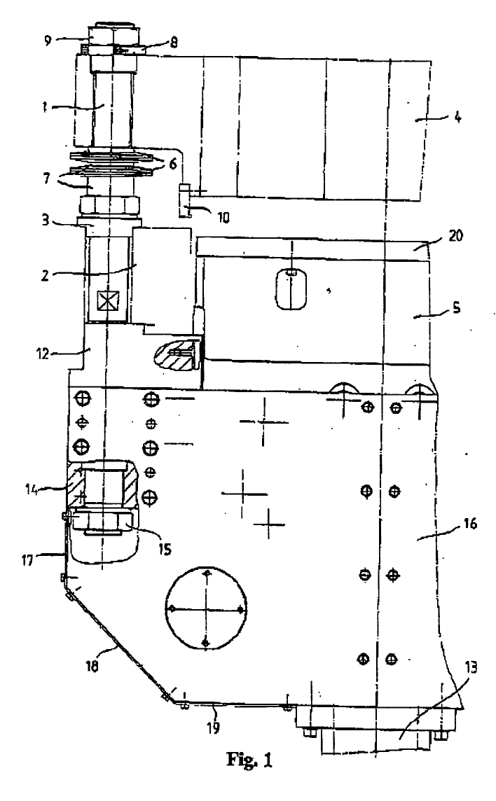

FIG. 1 shows only the left part of a device to cut films, in particular, soft films.

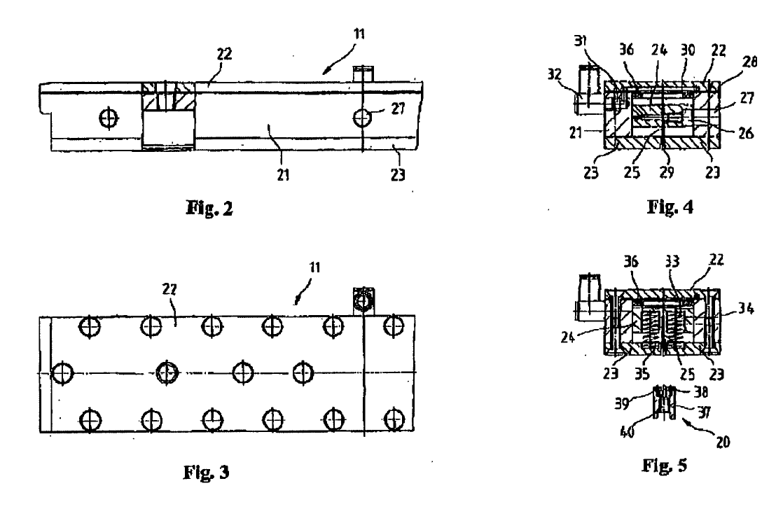

The right part of the device is correspondingly structured. The device contains two opposing guide columns 1, which are arranged within a machine frame 2 over two side guide plates 3, protruding from these plates upwards and downwards. An upper carrier 4 and a lower carrier 5, which is movable in contrast to the upper carrier, are conducted on the two guide columns 1. The upper carrier is arranged so that it can move vertically on the parts of the two guide columns 1 which protrude upwards from the guide plates 3, and is put under tension, upwards, by a plate spring arrangement 6 and guide rings 7 against a graduated ring 8 and a collar nut 9 at the upper end of the two guide columns 2. By rotating the graduated ring 8, the position of the carrier 5, with respect to the two guide columns 1, can be changed to adapt the device to different film thicknesses. Lateral guides 10, into which a blade holder 11, shown in FIGS. 2 to 5 and described in more detail in the following, is inserted, are affixed on the underside of the upper carrier 4.

The lower carrier 5 is affixed on a receiver 12 which is guided in such a way that the level can be adjusted via lateral guide bushes and so that it can be displaced on the part of the two guide columns 1, arranged below the guide plate 3, and which can be displaced vertically, relative to the upper carrier 4, by a lifting drive 13, constructed, for example, as a pneumatic cylinder. The lifting drive 13 is affixed to a lower part 14, which is held stationary, by means of screws 15, on the lower end of the two guide columns 1. Front and rear lateral parts 16, with lateral cover plates 17 to 19, are affixed on the lower part 14. A counterpiece 20, corresponding to the blade, in the form of a pressure ridge, shown in more detail in FIG. 5, is mounted on the lower carrier 5.

The blade holder 11, shown in FIGS. 2 to 5, contains a housing composed of a frame-like basic body 21, a cover plate, 22, and two lateral ridges, in which a plate-shaped pressure piston 24 is conducted in a displaceable manner. A blade 25 is affixed, by means of lateral screws 26, protruding downwards, on the underside of the vertically movable pressure piston 24. Openings 27 are provided for access to the screws 26 in one of the side walls of the basic body 21. The cover plate 22 is screwed tightly on the upper side of the basic body 21. A sealing plate 28 is located between the cover plate 22 and the basic body 21. The two lateral ridges 23 are affixed on the underside of the basic body 21 in such a way that a gap 29 for the blade 25 is formed between them. On the underside of the cover plate 22, a depression 30 is worked in, which forms a pressure space for the action on the pressure piston 24 with a pressure fluid, preferably, compressed air. A borehole 31, located in the basic body 21, on which an angular swiveling-screw fitting is connected as a connection 32 for the supply of the pressure fluid, leads to the depression 30.

As can be seen, particularly from FIG. 5, several pressure springs 33, located on both sides of the blade 12, are provided on the underside of the pressure piston 24; by means of the springs, the pressure piston 24 is pressed into an upper starting position. The pressure springs 33 are clamped between boreholes 34 on the underside of the pressure piston 24 and corresponding recesses 35 on the inside of the two lateral plates 23. A plastic ring 36 is located on the upper side of the pressure piston 24.

FIG. 5 also shows the counterpiece 20, affixed on the lower carrier 5. This consists of a pressure ridge 37, which can be mounted on the carrier 5 and which has an upper groove 38 to receive the blade 25. On the upper side of the pressure ridge 37, pressure pieces 39, made of rubber or another suitable material, are inserted on both sides of the groove 38. Boreholes 40 to affix the pressure ridge 37 on the lower carrier are provided in the pressure ridge 37.

In the device described in the preceding, the lower carrier 5 is first moved upwards, with the aid of the lifting drive, until the film to be cut is pressed by the pressure piece 39, located on the pressure ridge 37, to the lower side of the lateral plates 23. In this way, the film to be cut is clamped in the area of the cutting line. Then, pressure is applied via a pressure conduit and the angular screw fitting 32, whereby the pressure piston 24 moves against the force of the pressure springs 33 in the direction of the counterpiece 20 and the blade 25 meshes into the groove 38 of the pressure ridge 37. The film is thereby cut. Subsequently, the pressure applied on the housing can be reduced, so that the blade 25 withdraws due to the force of the pressure springs 33, once more, into the housing of the blade holder 11. By the return of the lower carrier 5, the cut film can then be released.

1. In a device to cut films, in particular, soft films, having a first carrier and a second carrier, which, in contrast to the first carrier, is movable, of which one carrier carries a blade holder with a movable blade and the other carrier has a counterpiece correspondingly aligned with the blade, the improvement in that the blade holder comprises a housing, a pressure piston mounted in the housing, on which the blade is held so that it can be replaced, the pressure piston being displaceable within the housing, and wherein the pressure piston is arranged to be movable by a pressure fluid in the direction of the counterpiece.

2. In a device according to claim 1, wherein the pressure piston is in the form of a pressure plate.

3. In a device according to claim 1, wherein the housing is composed of a frame-like basic part, an upper cover plate, and two lower lateral plates.

4. In a device according to claim 1, wherein the pressure piston is held by pressure springs in a repose starting position with the blade withdrawn into the housing.

5. In a device according to claim 3, wherein a gap is formed between the two lateral plates for passage of the blade.

6. In a device according to claim 5, wherein pressure springs are clamped between the lower lateral plates and the pressure piston.

7. In a device according to claim 3, wherein a depression is provided in the cover plate, for the formation of a pressure space to receive a pressurized fluid for action on the pressure piston for its movement in the direction of the counterpiece.

8. In a device according to claim 1, wherein the blade is affixed on the pressure piston via screws.

9. In a device according to claim 1, wherein a plastic ring is located on the side of the pressure piston.

10. In a device according to claim 1, wherein a borehole with a connection for the supply of pressure fluid to the pressure piston is provided in the housing.

11. In a device according to claim 1, wherein the counterpiece comprises a pressure ridge with an upper groove to receive the blade.

12. In a device according to claim 11, wherein the pressure ridge contains at least one pressure piece on its upper side facing the blade holder.
